(19) United States
(12) Patent Application Publication
(10) Pub. No.: US 2026/0263998 A1
(43) Pub. Date: Sep. 10, 2026

(54) CARBON DIOXIDE SEPARATION DEVICE

(71) Applicant: HONDA MOTOR CO., LTD., Tokyo (JP)

(72) Inventor: Takuma Arai, Wako-shi (JP)

(21) Appl. No.: 19/542,723

(22) Filed: Feb. 18, 2026

(30) Foreign Application Priority Data
Mar. 6, 2025 (JP) 2025-035362

(51) Int. Cl. B01D 53/22

(52) U.S. Cl. CPC B01D 53/226; B01D 53/229; B01D 2256/10; B01D 2257/504

(57) ABSTRACT

A carbon dioxide separation device includes a first membrane separator configured to introduce a raw material gas containing carbon dioxide, a second membrane separator configured to introduce a first non-permeate gas that has not permeated through membrane separation in the first membrane separator, a combustor provided on the downstream side of the second membrane separator and configured to combust a second permeate gas, a third membrane separator provided on the downstream side of the combustor, and at least one fourth membrane separator provided on the downstream side of the third membrane separator.

### CROSS-REFERENCE TO RELATED APPLICATION

Priority is claimed on Japanese Patent Application No. 2025-035362, filed March 06, 2025, the content of which is incorporated herein by reference.

### BACKGROUND OF THE INVENTION

### Field of the Invention

The present invention relates to a carbon dioxide separation device.

### Description of Related of Art

For example, as a technology for separating and recovering carbon dioxide (CO₂) from a natural gas containing methane (CH₄), there is known a carbon dioxide separation device including a raw material gas introduction line which introduces a raw material gas containing carbon dioxide, a first membrane separator which is connected to an end portion of the raw material gas introduction line and performs membrane separation of carbon dioxide from the raw material gas, a first permeate gas discharge line which discharges a first permeate gas that has permeated through the membrane separation in the first membrane separator, a first non-permeate gas discharge line which discharges a first non-permeate gas that has not permeated through the membrane separation in the first membrane separator, a second membrane separator which is provided downstream of the first membrane separator and separates carbon dioxide from the first non-permeate gas through membrane separation, a second permeate gas discharge line which discharges a second permeate gas that has permeated through the membrane separation in the second membrane separator, and a second permeate gas return line which branches off from a part of the second permeate gas discharge line and returns the second permeate gas to the raw material gas or the first non-permeate gas (refer to, for example, Japanese Unexamined Patent Application, First Publication No. 2016-93767).

### SUMMARY OF THE INVENTION

In a carbon dioxide separation device, when a carbon dioxide recovery device is installed and carbon dioxide is returned to the upstream side of a combustor (a boiler), there is a possibility that combustion in the combustor will be affected. Specifically, there are problems such as generation of carbon monoxide and misfires in the combustor. Thus, it is difficult to install the carbon dioxide recovery device, and a process design that avoids these problems is required.

An aspect of the present invention provides a carbon dioxide separation device that curbs generation of carbon monoxide and misfires in a combustor even when carbon dioxide is returned to the upstream side of the combustor. The aspect of the present invention contributes to improved energy efficiency.

The present invention has the following aspects.

[1] There is provided a carbon dioxide separation device including a raw material gas introduction line configured to introduce a raw material gas containing carbon dioxide, a first membrane separator connected to an end portion of the raw material gas introduction line and configured to introduce the raw material gas, a first permeate gas discharge line configured to discharge nitrogen gas that has permeated through membrane separation in the first membrane separator, a first non-permeate gas discharge line configured to discharge a first non-permeate gas that has not permeated through membrane separation in the first membrane separator, a second membrane separator connected to an end portion of the first non-permeate gas discharge line and configured to introduce the first non-permeate gas, a second permeate gas discharge line configured to discharge a second permeate gas that has permeated through membrane separation in the second membrane separator, a second non-permeate gas discharge line configured to discharge a second non-permeate gas that has not permeated through the membrane separation of the second membrane separator, a combustor provided on a downstream side of the second membrane separator and configured to combust the second permeate gas, a combustion gas discharge line connected to the combustor and configured to discharge a combustion gas obtained by combusting the second permeate gas in the combustor, a third membrane separator provided on a downstream side of the combustor and connected to the combustion gas discharge line, a third permeate gas discharge line configured to discharge a third permeate gas that has permeated through membrane separation in the third membrane separator, and a third non-permeate gas discharge line configured to discharge a third non-permeate gas that has not permeated through the membrane separation in the third membrane separator and to supply the third non-permeate gas to the second membrane separator.

According to the above aspect, since the first membrane separator that performs membrane separation of nitrogen gas contained in the raw material gas is provided in advance on the upstream side of the second membrane separator that performs membrane separation of the raw material gas containing carbon dioxide, even when a permeate gas mainly composed of carbon dioxide that has permeated through membrane separation in the second membrane separator provided on the upstream side of the combustor is supplied to the combustor from the second membrane separator, it is possible to curb generation of carbon monoxide or misfires in the combustor.

[2] The carbon dioxide separation device according to the aspect of [1] may further include a first vacuum pump provided in a middle of the third permeate gas discharge line and configured to supply the third permeate gas to a fourth membrane separator, at least one fourth membrane separator provided on a downstream side of the third membrane separator and connected to the third permeate gas discharge line, a fourth permeate gas discharge line configured to discharge a fourth permeate gas that has permeated through membrane separation in the fourth membrane separator, a fourth non-permeate gas discharge line configured to discharge a fourth non-permeate gas that has not permeated through the membrane separation in the fourth membrane separator and to supply the fourth non-permeate gas to the combustion gas discharge line, and a second vacuum pump provided in a middle of the fourth permeate gas discharge line.

According to the above aspect, it is possible to curb the generation of carbon monoxide and misfires in the combustor.

[3] The carbon dioxide separation device according to the aspect of [1] may further include a first vacuum pump provided in a middle of the first permeate gas discharge line and configured to discharge the nitrogen gas from the first membrane separator.

According to the above aspect, the nitrogen gas that separated through membrane separation in the first membrane separator can be efficiently discharged from the first membrane separator. A nitrogen concentration of the first non-permeate gas that is discharged from the first membrane separator can be adjusted.

[4] In the carbon dioxide separation device according to the aspect of [3] when an oxygen concentration on the downstream side of the second membrane separator is equal to or higher than a predetermined value, a pressure of the first vacuum pump may be reduced.

According to the above aspect, combustion efficiency of the combustor can be improved by reducing the oxygen concentration supplied to the combustor.

[5] In the carbon dioxide separation device according to the aspect of [3], when an oxygen concentration on the downstream side of the second membrane separator is less than a predetermined value and a carbon monoxide concentration on the downstream side of the combustor is equal to or higher than a predetermined value, the pressure of the first vacuum pump may be increased.

According to the above aspect, the combustion efficiency of the combustor can be improved by increasing the concentration of oxygen supplied to the combustor.

[6] In the carbon dioxide separation device according to the aspect of [3], when an oxygen concentration on the downstream side of the second membrane separator is less than a predetermined value and a carbon monoxide concentration on the downstream side of the combustor is less than a predetermined value, the pressure of the first vacuum pump may be reduced.

According to the above aspect, the oxygen concentration supplied to the combustor can be increased and decreased to stabilize combustion in the combustor.

According to an aspect of the present invention, it is possible to provide a carbon dioxide separation device that curbs the generation of carbon monoxide and misfires in the combustor even when carbon dioxide is returned to the upstream side of the combustor.

### BRIEF DESCRIPTION OF THE DRAWINGS

FIG. 1 is a schematic diagram showing a carbon dioxide separation device according to a first embodiment of the present invention.

FIG. 2 is a flowchart of a carbon dioxide separation method using the carbon dioxide separation device according to the first embodiment of the present invention.

FIG. 3 is a schematic diagram showing a carbon dioxide separation device according to a second embodiment of the present invention.

### DETAILED DESCRIPTION OF THE INVENTION

Hereinafter, an embodiment of the present invention will be described.

### Carbon dioxide separation device

### First embodiment

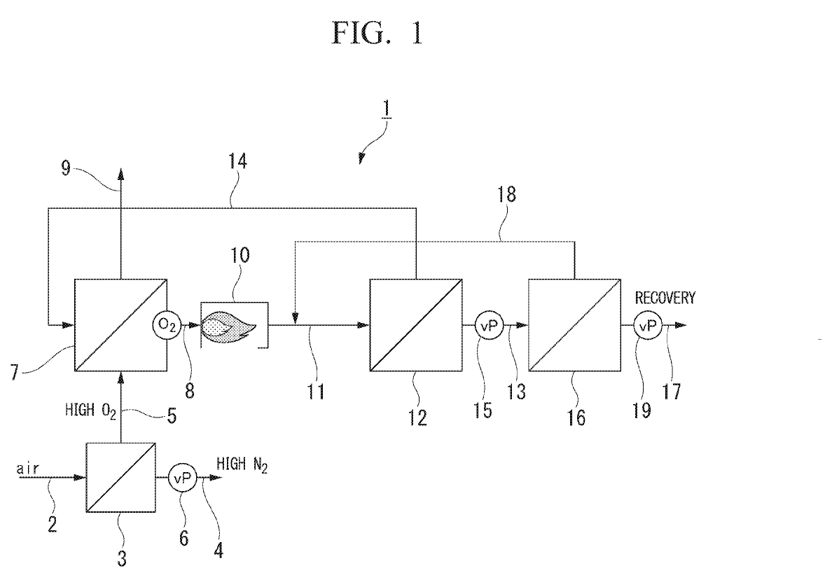

FIG. 1 is a schematic diagram showing a carbon dioxide separation device according to this embodiment.

As shown in FIG. 1, the carbon dioxide separation device 1 of this embodiment includes a raw material gas introduction line 2, a first membrane separator 3, a first permeate gas discharge line 4, a first non-permeate gas discharge line 5, a second membrane separator 7, a second permeate gas discharge line 8, a second non-permeate gas discharge line 9, a combustor 10, a combustion gas discharge line 11, a third membrane separator 12, a third permeate gas discharge line 13, a third non-permeate gas discharge line 14, a second vacuum pump 15, a fourth membrane separator 16, a fourth permeate gas discharge line 17, a fourth non-permeate gas discharge line 18, and a third vacuum pump 19. The carbon dioxide separation device 1 of this embodiment preferably includes a first vacuum pump 6.

The raw material gas introduction line 2 serves to introduce a raw material gas containing carbon dioxide into the first membrane separator 3.

The first membrane separator 3 is connected to an end portion of the raw material gas introduction line 2 and serves to introduce the raw material gas. The first membrane separator 3 is connected to the end portion of the raw material gas introduction line 2 and serves to separate nitrogen contained in the raw material gas in advance and to supply the raw material gas from which nitrogen has been separated to the second membrane separator 7 via the first non-permeate gas discharge line 5. By separating nitrogen contained in the raw material gas in advance, a recovery rate of carbon dioxide is improved.

The first permeate gas discharge line 4 serves to discharge the nitrogen gas that has permeated through membrane separation of the first membrane separator 3 from the first membrane separator 3.

The first non-permeate gas discharge line 5 serves to discharge the first non-permeate gas that has not permeated through the membrane separation in the first membrane separator 3 from the first membrane separator 3 and to supply it to the second membrane separator 7.

The first vacuum pump 6 is provided in the middle of the first permeate gas discharge line 4 and serves to discharge the nitrogen gas from the first membrane separator 3.

The second membrane separator 7 is connected to an end portion of the first non-permeate gas discharge line 5 and serves to introduce the first non-permeate gas. Further, the second membrane separator 7 is for membrane separation of the first non-permeate gas supplied from the first membrane separator 3. As the second membrane separator 7, a carbon dioxide separator equipped with a general carbon dioxide separation membrane can be used.

The second permeate gas discharge line 8 is connected to the second membrane separator 7 and serves to discharge a second permeate gas that has permeated through the membrane separation of the second membrane separator 7 from the second membrane separator 7.

The second non-permeate gas discharge line 9 is connected to the second membrane separator 7 and serves to discharge a second non-permeate gas that has not permeated through the membrane separation in the second membrane separator 7.

The combustor 10 is provided downstream of the second membrane separator 7 and connected to the second permeate gas discharge line 8, and serves to combust the second permeate gas.

The combustion gas discharge line 11 is connected to the combustor 10 and serves to discharge a combustion gas obtained by combusting the second permeate gas in the combustor 10 to the downstream side of the combustor 10.

The third membrane separator 12 is provided on the downstream side of the combustor 10 and connected to the combustion gas discharge line 11. Further, the third membrane separator 12 serves to perform the membrane separation of the combustion gas supplied from the combustor 10. As the third membrane separator 12, a carbon dioxide separator equipped with a general carbon dioxide separation membrane can be used.

The third permeate gas discharge line 13 is connected to the third membrane separator 12 and serves to discharge a third permeate gas that has permeated through membrane separation in the third membrane separator 12.

The third non-permeate gas discharge line 14 is connected to the third membrane separator 12 and serves to discharge the third non-permeate gas that has not permeated through the membrane separation of the third membrane separator 12 and to supply it to the second membrane separator 7.

The second vacuum pump 15 is provided in the middle of the third permeate gas discharge line 13 and serves to supply the third permeate gas to the fourth membrane separator 16.

The fourth membrane separator 16 is provided on the downstream side of the third membrane separator 12 and connected to the third permeate gas discharge line 13. Further, the fourth membrane separator 16 serves to perform membrane separation of the third permeate gas supplied from the third membrane separator 12. As the fourth membrane separator 16, a carbon dioxide separator equipped with a general carbon dioxide separation membrane can be used.

The fourth permeate gas discharge line 17 is connected to the fourth membrane separator 16 and serves to discharge the fourth permeate gas that has permeated through the membrane separation of the fourth membrane separator 16 from the fourth membrane separator 16.

The fourth non-permeate gas discharge line 18 is connected to the fourth membrane separator 16 and serves to discharge the fourth non-permeate gas that has not permeated through the membrane separation of the fourth membrane separator 16 and to supply it to the combustion gas discharge line 11.

The third vacuum pump 19 is provided in the middle of the fourth non-permeate gas discharge line 18 and serves to discharge the fourth permeate gas from the fourth membrane separator 16.

The control logic of the carbon dioxide separation device of this embodiment will be described.

When an oxygen concentration on the downstream side of the second membrane separator 7 is equal to or higher than a predetermined value, a pressure of the first vacuum pump 6 is reduced. Thus, combustion efficiency of the combustor 10 can be improved by reducing the oxygen concentration supplied to the combustor 10.

Furthermore, when the oxygen concentration on the downstream side of the second membrane separator 7 is less than a predetermined value and a carbon monoxide concentration on the downstream side of the combustor 10 is equal to or greater than a predetermined value, the pressure of the first vacuum pump 6 is increased. Thus, the combustion efficiency of the combustor 10 can be improved by increasing the oxygen concentration supplied to the combustor 10.

Furthermore, when the oxygen concentration on the downstream side of the second membrane separator 7 is less than a predetermined value and the carbon monoxide concentration on the downstream side of the combustor is less than a predetermined value, the pressure of the first vacuum pump 6 is reduced. Thus, the combustion efficiency of the combustor 10 can be stabilized by reducing the oxygen concentration supplied to the combustor 10.

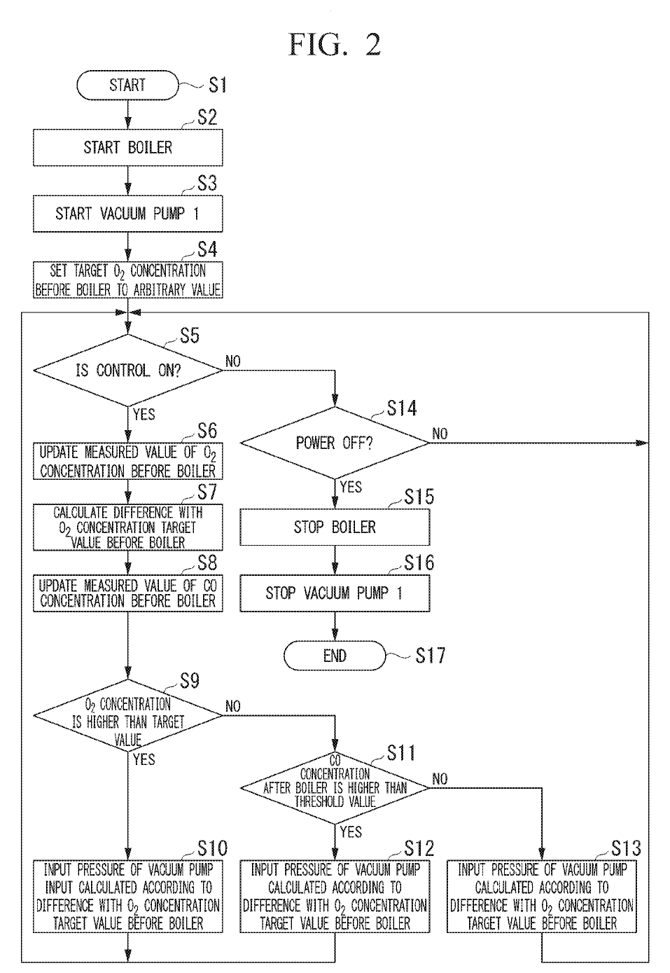

FIG. 2 is a flowchart of a carbon dioxide separation method using the carbon dioxide separation device of this embodiment.

The carbon dioxide separation device 1 is powered on to operate the carbon dioxide separation device 1 (Step: S1). Then, the combustor 10 starts (Step: S2), and the first vacuum pump 6 starts (Step: S3).

Next, the oxygen concentration of the second permeate gas to be supplied to the combustor 10 is set to an arbitrary value (Step: S4).

It is confirmed whether or not the control of the oxygen concentration of the second permeate gas supplied to the combustor 10 is to be continued (Step: S5). When the control of the oxygen concentration of the second permeate gas supplied to the combustor 10 is to be continued, the oxygen concentration of the second permeate gas supplied to the combustor 10 is measured, and a target value of the oxygen concentration of the second permeate gas supplied to the combustor 10 is updated (Step: S6).

Next, a difference between the measured value of the oxygen concentration of the second permeate gas supplied to the combustor 10 and the target value of the oxygen concentration of the second permeate gas supplied to the combustor 10 is calculated (Step: S7). A carbon dioxide concentration of the combustion gas discharged from the combustor 10 is measured according to the difference, and the target value of the oxygen concentration of the second permeate gas supplied to the combustor 10 is updated (Step: S8).

At the upstream side of the combustor 10, it is confirmed whether or not the oxygen concentration of the second permeate gas supplied to the combustor 10 is higher than the target value (Step: S9).

When the oxygen concentration of the second permeate gas supplied to the combustor 10 is higher than the target value, a difference between the measured value of the oxygen concentration of the second permeate gas supplied to the combustor 10 and the target value of the oxygen concentration of the second permeate gas supplied to the combustor 10 is calculated, a pressure of the third permeate gas supplied to the fourth membrane separator 16 by the second vacuum pump 15 is set according to the difference, and the process returns to Step: S5 (Step: S10).

When the oxygen concentration of the second permeate gas supplied to the combustor 10 is lower than the target value, at the downstream side of the combustor 10, the carbon dioxide concentration of the combustion gas discharged from the combustor 10 is measured, and it is confirmed whether or not the carbon dioxide concentration is higher than a threshold value (Step: S11).

When the carbon dioxide concentration is higher than the threshold value, a difference between the measured value of the oxygen concentration of the second permeate gas supplied to the combustor 10 and the target value of the oxygen concentration of the second permeate gas supplied to the combustor 10 is calculated, the pressure of the third permeate gas supplied to the fourth membrane separator 16 by the second vacuum pump 15 is set according to the difference, and the process returns to Step: S5 (Step: S12).

When the carbon dioxide concentration is less than the threshold value, a difference is calculated between the measured value of the oxygen concentration of the second permeate gas supplied to the combustor 10 and the target value of the oxygen concentration of the second permeate gas supplied to the combustor 10, the pressure of the third permeate gas supplied to the fourth membrane separator 16 by the second vacuum pump 15 is set according to the difference, and the process returns to Step: S5 (Step: S13).

When the control of the oxygen concentration of the second permeate gas supplied to the combustor 10 is not to be continued, it is determined whether or not the power to the carbon dioxide separation device 1 is to be turned off (Step: S14). When the power to the carbon dioxide separation device 1 is not to be turned off, the process returns to Step: S5.

When the power supply to the carbon dioxide separation device 1 is turned off, the combustor 10 is stopped (Step: S15), the first vacuum pump 6 is stopped (Step: S16), and the operation of the carbon dioxide separation device 1 is stopped (Step: S17).

According to the carbon dioxide separation device 1 of this embodiment, since the first membrane separator 3 that performs membrane separation of nitrogen gas contained in the raw material gas is provided in advance on the upstream side of the second membrane separator 7 that performs membrane separation of the raw material gas containing carbon dioxide, even when the permeate gas mainly composed of carbon dioxide that has been permeated by membrane separation in the second membrane separator 7 is supplied to the combustor 10 from the second membrane separator 7 provided on the upstream side of the combustor 10, the generation of carbon monoxide and misfires in the combustor 10 can be curbed.

### Second embodiment

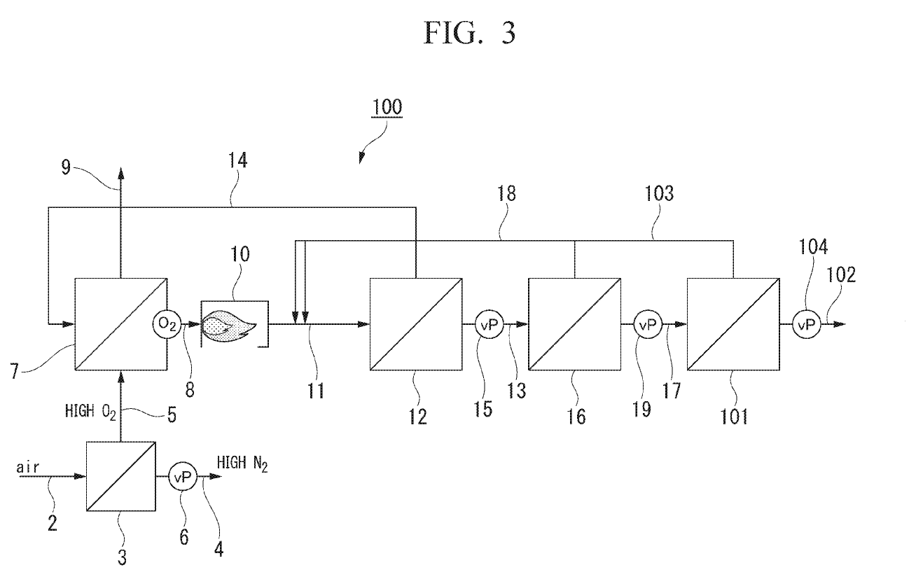

FIG. 3 is a schematic diagram showing a carbon dioxide separation device according to this embodiment. In FIG. 3, components identical to those shown in FIG. 1 are designated by the same reference numerals, and their description will be omitted.

As shown in FIG. 3, the carbon dioxide separation device 100 of this embodiment includes a fifth membrane separator 101, a fifth permeate gas discharge line 102, a fifth non-permeate gas discharge line 103, and a fourth vacuum pump 104, in addition to the above-described carbon dioxide separation device 1.

The fifth membrane separator 101 is provided on the downstream side of the fourth membrane separator 16 and is connected to the fourth non-permeate gas discharge line 18. Further, the fifth membrane separator 101 serves to perform membrane separation of the third permeate gas supplied from the fourth membrane separator 16. As the fifth membrane separator 101, a carbon dioxide separator equipped with a general carbon dioxide separation membrane can be used.

The fifth permeate gas discharge line 102 is connected to the fifth membrane separator 101 and serves to discharge a fifth permeate gas that has permeated through the membrane separation of the fifth membrane separator 101 from the fifth membrane separator 101.

The fifth non-permeate gas discharge line 103 is connected to the fifth membrane separator 101 and serves to discharge the fifth non-permeate gas that has not permeated through the membrane separation of the fifth membrane separator 101 and to supply it to the combustion gas discharge line 11.

The fourth vacuum pump 104 is provided in the middle of the fifth permeate gas discharge line 102 and serves to discharge the fifth permeate gas from the fifth membrane separator 101.

According to the carbon dioxide separation device 100 of this embodiment, it is possible to further increase the carbon dioxide recovery rate by providing the fifth membrane separator 101.

Although the embodiments of the present invention have been described in detail above, the present invention is not limited to the above embodiments, and various modifications and changes are possible within the scope of the gist of the present invention as described in the claims.

What is claimed is:

1. A carbon dioxide separation device comprising:
a raw material gas introduction line configured to introduce a raw material gas containing carbon dioxide;
a first membrane separator connected to an end portion of the raw material gas introduction line and configured to introduce the raw material gas;
a first permeate gas discharge line configured to discharge nitrogen gas that has permeated through membrane separation in the first membrane separator;
a first non-permeate gas discharge line configured to discharge a first non-permeate gas that has not permeated through membrane separation in the first membrane separator;
a second membrane separator connected to an end portion of the first non-permeate gas discharge line and configured to introduce the first non-permeate gas;
a second permeate gas discharge line configured to discharge a second permeate gas that has permeated through membrane separation in the second membrane separator;
a second non-permeate gas discharge line configured to discharge a second non-permeate gas that has not permeated through the membrane separation of the second membrane separator;
a combustor provided on a downstream side of the second membrane separator and configured to combust the second permeate gas;
a combustion gas discharge line connected to the combustor and configured to discharge a combustion gas obtained by combusting the second permeate gas in the combustor;
a third membrane separator provided on a downstream side of the combustor and connected to the combustion gas discharge line;
a third permeate gas discharge line configured to discharge a third permeate gas that has permeated through membrane separation in the third membrane separator; and
a third non-permeate gas discharge line configured to discharge a third non-permeate gas that has not permeated through the membrane separation in the third membrane separator and to supply the third non-permeate gas to the second membrane separator.

2. The carbon dioxide separation device according to claim 1, further comprising:
a first vacuum pump provided in a middle of the third permeate gas discharge line and configured to supply the third permeate gas to a fourth membrane separator;
at least one fourth membrane separator provided on a downstream side of the third membrane separator and connected to the third permeate gas discharge line;
a fourth permeate gas discharge line configured to discharge a fourth permeate gas that has permeated through membrane separation in the fourth membrane separator;
a fourth non-permeate gas discharge line configured to discharge a fourth non-permeate gas that has not permeated through the membrane separation in the fourth membrane separator and to supply the fourth non-permeate gas to the combustion gas discharge line; and
a second vacuum pump provided in a middle of the fourth permeate gas discharge line.

3. The carbon dioxide separation device according to claim 1, further comprising a first vacuum pump provided in a middle of the first permeate gas discharge line and configured to discharge the nitrogen gas from the first membrane separator.

4. The carbon dioxide separation device according to claim 3, wherein, when an oxygen concentration on a downstream side of the second membrane separator is equal to or higher than a predetermined value, a pressure of the first vacuum pump is reduced.

5. The carbon dioxide separation device according to claim 3, wherein, when an oxygen concentration on a downstream side of the second membrane separator is less than a predetermined value and a carbon monoxide concentration on a downstream side of the combustor is equal to or higher than a predetermined value, a pressure of the first vacuum pump is increased.

6. The carbon dioxide separation device according to claim 3, wherein, when an oxygen concentration on a downstream side of the second membrane separator is less than a predetermined value and a carbon monoxide concentration on a downstream side of the combustor is less than a predetermined value, a pressure of the first vacuum pump is reduced.
